(19) United States
(12) Patent Application Publication
(10) Pub. No.: US 2011/0227867 A1
(43) Pub. Date: Sep. 22, 2011

(54) TOUCH PANEL AND ELECTRO-OPTICAL APPARATUS WITH INPUTTING FUNCTION

(75) Inventors: Shinji Ogawa, Nagano (JP); Mamoru Nakamura, Nagano (JP); Yukihisa Kobayashi, Nagano (JP); Yoshikiyo Kashii, Nagano (JP); Atsushi Yoshiyama, Nagano (JP)

(73) Assignee: SONY CORPORATION, Tokyo (JP)

(21) Appl. No.: 13/049,356

(22) Filed: Mar. 16, 2011

(30) Foreign Application Priority Data
Mar. 19, 2010 (JP) P2010-063869

(51) Int. Cl. G06F 3/045; G06F 3/041

(52) U.S. Cl. 345/174; 345/173

(57) ABSTRACT

Disclosed herein is a touch panel, including: a sensor substrate for input position detection secured to a metal framework disposed on the opposite side to an inputting operation face side thereof with an adhering member interposed therebetween; a light transmitting conductive film formed on the face of the sensor substrate on the opposite side to the inputting operation face so as to extend to edges of the sensor substrate, a potential different from a potential of the metal framework being applied to the light transmitting conductive film; and a water-repellent coating layer for continuously covering from side end faces of the sensor substrate to the metal framework.

### CROSS REFERENCES TO RELATED APPLICATIONS

The present application claims priority to Japanese Priority Patent Application JP 2010-063869 filed with the Japan Patent Office on Mar. 19, 2010, the entire content of which is hereby incorporated by reference.

### BACKGROUND

This application relates to a touch panel wherein a sensor substrate is secured to a metal framework and an electro-optical apparatus with an inputting function which includes the touch panel.

A liquid crystal apparatus which includes a liquid crystal panel of the transmission type or the semi-transmission reflection type or an organic electroluminescence apparatus which includes an organic electroluminescence display panel in which organic electroluminescence elements are configured is used widely for a display section of electronic equipment such as a portable telephone set or a personal digital assistant (PDA). It has been proposed in recent years that, in such an electro-optical apparatus as described above, a touch panel is placed on an electro-optical panel such as a liquid crystal panel or an organic electroluminescence display panel to form an electro-optical apparatus with an inputting function. See, for example, in Japanese Patent Laid-Open No. 2009-8703.

In the case where the electro-optical panel is a liquid crystal panel, as shown in FIG. 7, the electro-optical panel 10 is supported together with a backlight apparatus 80 from below by a lower metal framework 40 and a resin frame 30 formed integrally with or separately from the lower metal framework 40 at least on the inner side of the lower metal framework 40. Further, an upper metal framework 50 is placed on the upper side of the electro-optical panel 10. The upper metal framework 50 includes an upper plate portion 53 which has an opening 530 and overlaps with end portions of the electro-optical panel 10. A sensor substrate 20 of a touch panel 1 is secured to an upper portion of the upper plate portion 53 by adhesive 79 or the like.

If the electro-optical apparatus with an inputting function is configured in this manner, then there is the possibility that electromagnetic wave noise from the electro-optical panel 10 side may have an influence on the sensor substrate 20. Therefore, a configuration is applied wherein a light transmitting conductive film 28 for shielding is formed on the opposite side of the sensor substrate 20 to the inputting operation face side and a shield potential is applied to the light transmitting conductive film 28.

### SUMMARY

However, in the case where an electro-optical apparatus with an inputting function is configured in such a manner as described above with reference to FIG. 7, it has the following problem. In particular, if a moisture W sticks to a side end face 20g of the sensor substrate 20 when a potential different from a potential of the upper metal framework 50 which is the ground potential is applied as a shield potential to the light transmitting conductive film 28, then the light transmitting conductive film 28 and the upper metal framework 50 are short-circuited, resulting in variation of the potential of the light transmitting conductive film 28.

For example, in the case where the touch panel 1 is of the capacitance type, a shield potential of a waveform same as that of a signal to be supplied to the input position detecting electrode 21 is applied to a light transmitting conductive film 28 to prevent parasitic capacitance from appearing between the input position detecting electrode 21 and the light transmitting conductive film 28. If, in such an instance, the light transmitting conductive film 28 and the upper metal framework 50 are short-circuited and the ground potential is applied to the light transmitting conductive film 28, then some capacitance becomes parasitic between the input position detecting electrode 21 and the light transmitting conductive film 28. The parasitic capacitance deteriorates the position detection accuracy significantly.

Therefore, there is a need for the present application to provide a touch panel and an electro-optical apparatus with an inputting function wherein, also where a sensor substrate is secured to a metal framework, short-circuiting of a conductor film formed on the metal framework side face of the sensor substrate and the metal framework by moisture can be prevented.

In order to achieve the need described above, according to an embodiment, there is provided a touch panel including a sensor substrate for input position detection secured to a metal framework disposed on the opposite side to an inputting operation face side thereof with an adhering member interposed therebetween, a light transmitting conductive film formed on the face of the sensor substrate on the opposite side to the inputting operation face so as to extend to edges of the sensor substrate, a potential different from a potential of the metal framework being applied to the light transmitting conductive film, and a water-repellent coating layer for continuously covering from side end faces of the sensor substrate to the metal framework.

In the touch panel, the light transmitting conductive film is formed on the face of the sensor substrate on the opposite side to the inputting operation face so as to extend to the edges of the sensor substrate. Since the sensor substrate is secured, at the face thereof on which the light transmitting conductive film is formed, to the metal framework, the light transmitting conductive film and the metal framework are positioned closely to each other. Also in the case of such a configuration as just described, since the touch panel of the embodiment includes the water-repellent coating layer for continuously covering from the side end faces of the sensor substrate to the metal framework, even if moisture tends to stick to the side end faces of the sensor substrate and so forth, the light transmitting conductive film and the upper metal framework do not suffer from short-circuiting.

Preferably, an input position detecting electrode whose capacitance variation is monitored is formed on the inputting operation face side of the sensor substrate, and the light transmitting conducive film is a shielding electrode to which a potential different from the potential of the metal framework is applied. If the touch panel is of the capacitance type, then while a shield potential of a waveform same as that of a signal supplied to an input position detecting electrode is applied to the light transmitting conductive film to prevent some capacitance from being parasitic between the input position detecting electrode and the light transmission conductive film, whereby shielding is carried out. Even where such an active shield method as just described is adopted, with the touch panel of the present application, such a situation that the light transmitting conductive film and the metal framework are short-circuited to cause the ground potential to be applied to the light transmitting conductive film can be prevented. Therefore, the active shielding can be carried out favorably using the light transmitting conductive film.

Preferably, the metal framework has an upper plate portion on which the sensor substrate is mounted and side plate portions extending downwardly from outer peripheral edges of the upper plate portion, and the water-repellent coating layer continuously covers from the side end faces of the sensor substrate to the side plate portions of the metal framework. With this configuration, short-circuiting between the light transmitting conductive film and the metal framework to be caused by moisture can be prevented with certainty.

Preferably, a recessed portion is configured between the sensor substrate and the metal framework, and the water-repellent coating layer has a thickness which is thicker at a portion thereof in the recessed portion than at portions thereof which cover the side end faces of the sensor substrate and a portion which covers the metal framework. In the case where the recessed portion is configured between the sensor substrate and the metal framework, the recessed portion serves as a liquid reserving portion when water-repellent coating liquid is applied. Further, the film thickness of the water-repellent coating layer becomes thicker in the recessed portion than on the portions thereof which cover the side end faces of the sensor substrate and the portion thereof which covers the metal framework. Accordingly, even in the case where the film thickness of the water-repellent coating layer is made thinner at the portions thereof which cover the side end faces of the sensor substrate and the portion thereof which covers the metal framework to suppress the variation of the outside dimension, the water-repellent coating layer can continuously cover from the side end faces of the sensor substrate to the metal framework.

Preferably, a recessed portion in the form of a gap is configured between the sensor substrate and the metal framework, and the water-repellent coating layer fills the inside of the gap. In the case where the recessed portion in the form of a gap is configured between the sensor substrate and the metal framework, the recessed portion serves as a liquid reserving portion when water-repellant coating liquid is applied. Further, the film thickness of the water-repellent coating layer becomes thicker in the recessed portion than on the portions thereof which cover the side end faces of the sensor substrate and the portion thereof which covers the metal framework. Accordingly, even in the case where the film thickness of the water-repellent coating layer is made thinner at the portions thereof which cover the side end faces of the sensor substrate and the portion thereof which covers the metal framework to suppress the variation of the outside dimension, the water-repellent coating layer can continuously cover from the side end faces of the sensor substrate to the metal framework.

Preferably, the water-repellent coating layer is colored. In the case where the water-repellent coating layer is colored, even if the film thickness of the water-repellent coating layer is made thinner, it can be confirmed with certainty whether or not the water-repellent coating layer is formed.

The touch panel may be configured such that an insulating film is formed on the light transmitting conductive film on the face of the sensor substrate on the opposite side to the inputting operation face.

According to another embodiment, there is provided an electro-optical apparatus with an inputting function, including the touch panel according to the embodiment, and an electro-optical panel held on the metal framework.

The electro-optical apparatus with an inputting function to which the embodiment is applied is used in such electronic equipment as, for example, a portable telephone set or a personal digital assistant.

Additional features and advantages are described herein, and will be apparent from the following Detailed Description and the figures.

### BRIEF DESCRIPTION OF THE FIGURES

FIGS. 1A and 1B are a perspective view and a side elevational view, respectively, showing a general configuration of an electro-optical apparatus with an inputting function in the form of a liquid crystal apparatus with an inputting function according to an embodiment 1 of the present application;

FIG. 2 is an exploded perspective view of the electro-optical apparatus with an inputting function of FIGS. 1A and 1B;

FIGS. 3A and 3B are cross sectional views of the electro-optical apparatus with an inputting function of FIGS. 1A and 1B;

FIGS. 4A and 4B are a schematic plan view and a cross sectional view, respectively, showing a configuration of a sensor substrate used in the electro-optical apparatus with an inputting function of FIGS. 1A and 1B;

FIG. 5 is a cross sectional view of an end portion of an electro-optical apparatus with an inputting function according to an embodiment 2 of the present application;

FIGS. 6A and 6B are schematic perspective views showing different electronic equipment which include an electro-optical apparatus with an inputting function to which the embodiment is applied; and

FIG. 7 is a cross sectional view of an electro-optical apparatus with an inputting function according to a reference example to the present application.

### DETAILED DESCRIPTION

Embodiments of the present application will be described below in detail with reference to the drawings.

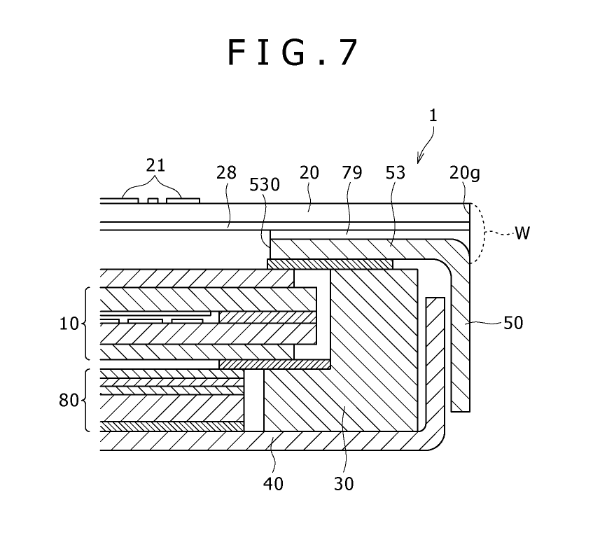

In the following, preferred embodiments of the present application are described with reference to the accompanying drawings. It is to be noted that, in the figures referred to in the following description, in order to show various layers and members in respective sizes with which they can be recognized on the drawings, the scales of them are suitably made different from each other. Further, in order to facilitate recognition of a relationship to the configuration described hereinabove with reference to FIG. 7, like elements are denoted by like reference symbols.

### Embodiment 1

(General Configuration)

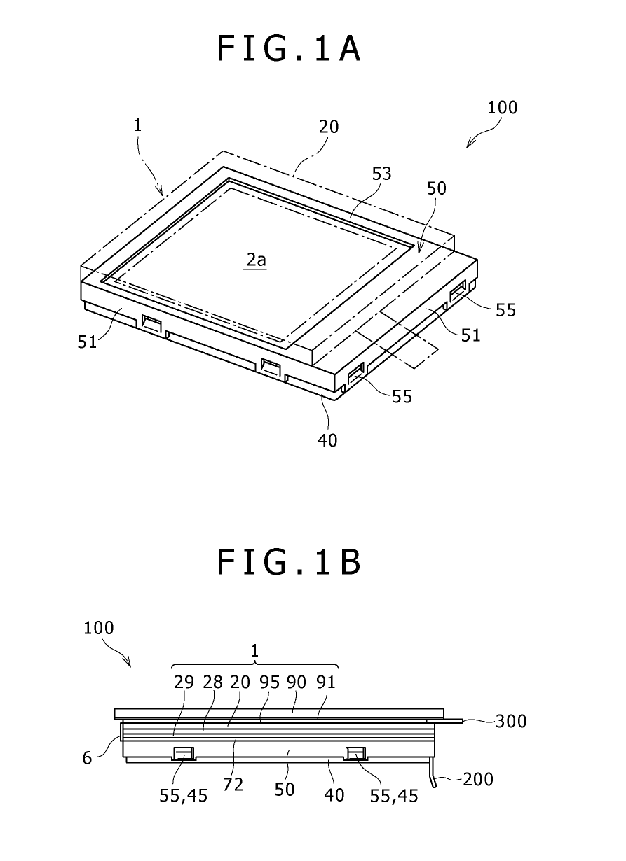

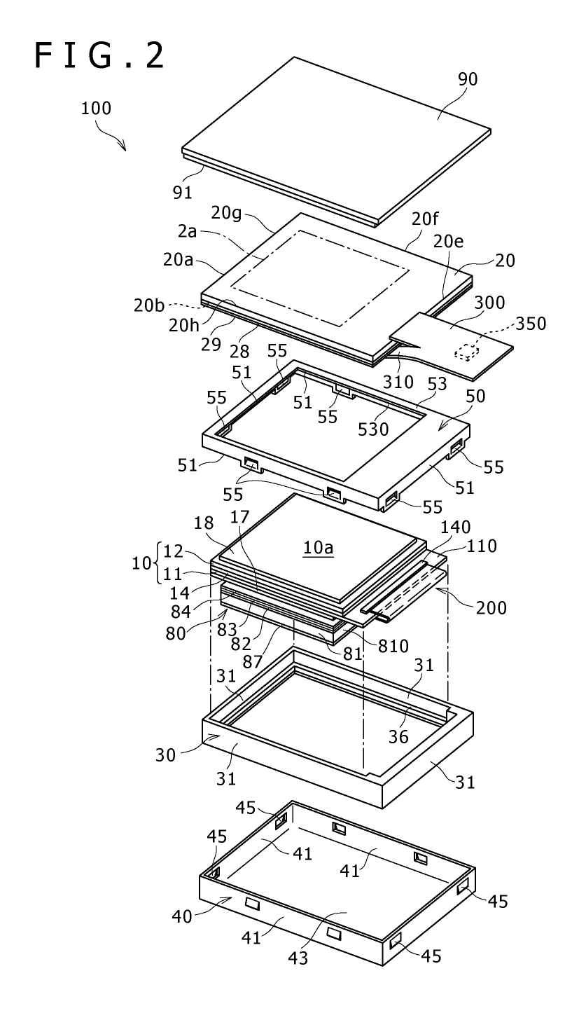

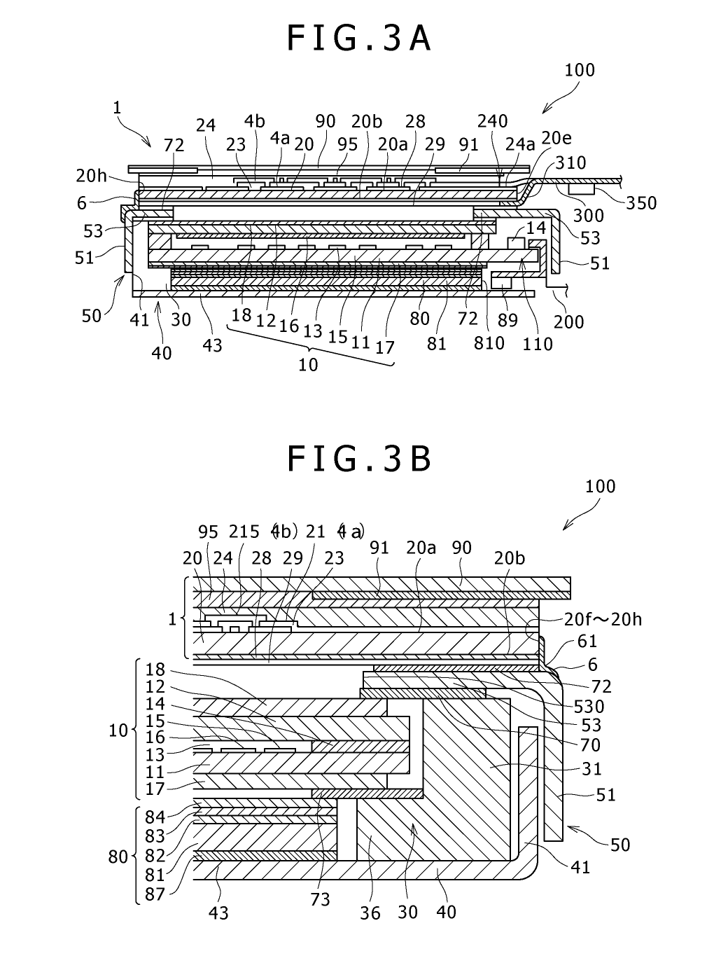

FIGS. 1A and 1B show a general configuration of an electro-optical apparatus with an inputting function, particularly a liquid crystal apparatus with an inputting function, according to an embodiment 1 of the present application. More particularly, FIGS. 1A and 1B are a schematic perspective view and a side elevational view, respectively, of the electro-optical apparatus with an inputting function. It is to be noted that, in FIG. 1A, a touch panel is indicated by dashed-dotted line while a cover is omitted. FIG. 2 shows the electro-optical apparatus with an inputting function of FIGS. 1A and 1B in an exploded perspective view. Meanwhile, FIGS. 3A and 3B show a cross sectional configuration of the electro-optical apparatus with an inputting function of FIGS. 1A and 1B and particularly are a cross sectional view of the entire electro-optical apparatus with an inputting function and an enlarged cross sectional view of an end portion of the electro-optical apparatus with an inputting function, respectively.

Referring first to FIGS. 1A, 1B and 2, the electro-optical apparatus 100 with an inputting function of the present embodiment includes a backlight apparatus 80, an electro-optical panel 10 disposed in an overlapping relationship on an upper face of the backlight apparatus 80, and a touch panel 1 of the capacitance type. The electro-optical panel 10 is formed from a liquid crystal panel of the transmission type or the semi-transmission reflection type.

The electro-optical apparatus 100 with an inputting function includes a resin frame 30 made of a resin for holding the electro-optical panel 10 and the backlight apparatus 80 on the inner side thereof, a lower metal framework 40 disposed on the lower wide of the resin frame 30 remotely from the display face, and an upper metal framework 50 disposed on the upper side of the resin frame 30, that is, on the display face side or inputting operation face side. The resin frame 30 and the lower metal framework 40 are sometimes formed integrally with each other by insert molding or outsert molding. Further, on the inner side of the upper metal framework 50, a resin part is sometimes formed by insert molding or outsert molding together with the upper metal framework 50.

Referring to FIGS. 2, 3A and 3B, the electro-optical panel 10 has a rectangular shape in plan and includes a device substrate 11 on which pixel electrodes 15 and so forth are formed, an opposing substrate 12 disposed in an opposing relationship to the device substrate 11 with a predetermined gap left therebetween, and a seal member 14 for adhering the opposing substrate 12 and the device substrate 11 to each other. A liquid crystal layer 13 is held in a region surrounded by the seal member 14. The device substrate 11 and the opposing substrate 12 are each formed from a light transmitting substrate such as a glass substrate. In the present embodiment, the opposing substrate 12 is disposed on the display light emitting side while the device substrate 11 is disposed on the backlight apparatus 80 side. In the present embodiment, the electro-optical panel 10 is configured as a liquid crystal panel of the TN (Twisted Nematic) type, the ECB (Electrically Controlled Birefringence) type or the VAN (Vertical Aligned Nematic) type. The pixel electrodes 15 are formed on the device substrate 11 while a common electrode 16 is formed on the opposing substrate 12. It is to be noted that, in the case where the electro-optical panel 10 is a liquid crystal panel of the IPS (In Plane Switching) type or the FFS (Fringe Field Switching) type, the common electrode 16 is provided on the device substrate 11 side. The device substrate 11 is sometimes disposed on the display light emitting side with respect to the opposing substrate 12.

A driving IC 140 is mounted on an upper face of an overhanging portion 110 of the device substrate 11 which overhangs from an edge of the opposing substrate 12, and a flexible circuit board 200 is connected to an end portion of the overhanging portion 110. An upper polarizing plate 18 is disposed in an overlapping relationship on an upper face of the electro-optical panel 10, and a lower polarizing plate 17 is disposed between the lower face of the electro-optical panel 10 and the backlight apparatus 80.

The backlight apparatus 80 includes a rectangular light guide plate 81 disposed in an overlapping relationship on the lower face side of the electro-optical panel 10, and a light emitting device 89 formed from an LED of the plane mounted type. The flexible circuit board 200 connected to the electro-optical panel 10 is a double-sided board, and the light emitting device 89 and so forth are mounted on the flexible circuit board 200. The light guide plate 81 has four side end faces, and that one of the side end faces on one end side on which the device substrate 11 of the electro-optical panel 10 overhangs from the opposing substrate 12 is an incident end face 810. In the case of the light guide plate 81, light incident to the incident end face 810 advances in the light guide plate 81 and goes out from an upper face of the light guide plate 81. In the present embodiment, a reflecting sheet 87 is disposed in an overlapping relationship with the lower face of the light guide plate 81. A plurality of optical sheets such as a diffusing plate 82 and prism sheets 83 and 84 are disposed in an overlapping relationship on the upper face of the light guide plate 81.

The resin frame 30 has a rectangular framework shape and has four side walls 31 opposing to the side end portions of the electro-optical panel 10. On the inner side of three ones of the four side walls 31, a stepped portion 36 is formed. On such stepped portion 36, the electro-optical panel 10 is secured by a double-sided adhesive tape 73 or the like, and the backlight apparatus 80 is disposed in the inner side of the stepped portion 36.

The lower metal framework 40 is formed by presswork of a thin metal plate of approximately 0.15 mm thick such as, for example, a SUS plate. The lower metal framework 40 has a bottom plate portion 43 and four side plate portions 41 erected uprightly from the outer peripheral edges of the bottom plate portion 43, and has a form of a rectangular box which is open at an upper face thereof. The resin frame 30 is held on the bottom plate portion 43 of the lower metal framework 40.

Also the upper metal framework 50 is formed by presswork of a thin metal plate of approximately 0.15 mm thick such as, for example, a SUS plate. The upper metal framework 50 has a rectangular upper plate portion 53, and four side plate portions 51 extending downwardly from the outer peripheral edges of the upper plate portion 53. The upper metal framework 50 thus has a shape of a rectangular box which is open at the lower face thereof. The side plate portions 51 cover the side end portions of the electro-optical panel 10, and the upper plate portion 53 covers a display light emitting face 10a of the electro-optical panel 10. Here, a rectangular opening 530 through which light emitted from the electro-optical panel 10 is emitted is formed in the upper plate portion 53 of the upper metal framework 50. Therefore, the upper metal framework 50 covers over an overall area of the outer peripheral end portions of the display light emitting face 10a of the electro-optical panel 10.

Obliquely downwardly directed hook portions 45 are formed on the side plate portions 41 of the lower metal framework 40 by cutting and setting up processing for the side plate portions 41 while obliquely upwardly directed hook portions 55 are formed on the side plate portions 51 of the upper metal framework 50 by cutting and setting up processing for the side plate portions 51. Here, the hook portions 45 are formed obliquely such that tip ends thereof are directed to the outer side while the hook portions 55 are formed obliquely such that tip ends thereof are directed to the inner side. Therefore, if the upper metal framework 50 is pressed downwardly toward the lower metal framework 40 in a state in which the lower metal framework 40 and the upper metal framework 50 are placed on the electro-optical panel 10, backlight apparatus 80 and resin frame 30, then the side plate portions 51 of the upper metal framework 50 are overlapped with the outer side of the side plate portions 41 of the lower metal framework 40. If, in this state, the upper metal framework 50 is further pressed toward the lower metal framework 40, then the tip end portions of the hook portions 55 enter the inner side of the hook portions 45 of the lower metal framework 40 and the hook portions 45 and 55 are automatically engaged with each other to establish a state in which the upper metal framework 50 and the lower metal framework 40 are coupled to each other at the side plate portions 41 and 51 thereof.

In the electro-optical apparatus 100 with an inputting function of the present embodiment, if a foreign matter entering the space surrounded by the resin frame 30, lower metal framework 40 and upper metal framework 50 comes out to the display light emitting face 10a side through a gap between the electro-optical panel 10 and the upper metal framework 50, then such a problem occurs that the display quality is deteriorated. Therefore, the electro-optical apparatus 100 with an inputting function of the present embodiment includes an adhesive layer 70 for closing up the gap between the electro-optical panel 10 and the upper metal framework 50 at the location at which the electro-optical panel 10 and the upper metal framework 50 overlap with each other.

(Configuration of the Touch Panel)

The touch panel 1 includes a sensor substrate 20, and a glass cover 90 a little greater than the sensor substrate 20. A central region of the sensor substrate 20 when viewed in plan serves as an inputting region 2a. Meanwhile, a region of the electro-optical panel 10 which overlaps with the inputting region 2a as viewed in plan serves as an image formation region. To the side on which a side end face 20e from among four side end faces 20e to 20h of the sensor substrate 20 is positioned, a flexible circuit board 300 is connected. A driving IC 350 is mounted on the flexible circuit board 300.

The sensor substrate 20 is formed from a glass plate, a plastic plate or the like. In the present embodiment, a glass substrate is used as the sensor substrate 20. It is to be noted that, in the case where the sensor substrate 20 is configured from a plastic material, the plastic material may be a heat-resisting light-transmitting sheet of a cyclic olefin resin such as PET (polyethylene terephthalate), PC (polycarbonate), PES (polyethersulfone), PI (polyimide) or polynorbornene. The glass cover 90 is made of chemically tempered glass.

The substrate face of the sensor substrate 20 which is positioned on the inputting operation face side is a first face 20a, and the substrate face positioned remotely from the inputting operation face side is a second face 20b. A lower layer side conductive film 4a, an interlayer insulating film 23, an upper layer side conductive film 4b and a light transmitting overcoat layer 24 are formed in order from the lower face side toward the upper face side as viewed from the sensor substrate 20 on the first face 20a of the sensor substrate 20. Input position detecting electrodes 21 are formed from the lower layer side conductive film 4a from between the lower layer side conductive film 4a and the upper layer side conductive film 4b. Further, repeating electrodes 215 are formed from the upper layer side conductive film 4b. On the sensor substrate 20 side on which the side end face 20e is positioned, mounting terminals 24a are formed on the first face 20a, and a mounting region 240 for the flexible circuit board 300 is formed from the mounting terminals 24a.

To the first face 20a side of the sensor substrate 20, the glass cover 90 is adhered by pressure sensitive adhesive 95, and an insulating light blocking layer 91 is printed in a region of the glass cover 90 which overlaps with an outer side region 2b, that is, a peripheral region, of the sensor substrate 20. The region surrounded by the light blocking layer 91 makes the inputting region 2a. The light blocking layer 91 has a function of hiding the mounting terminals 24a and so forth.

(Configuration of the Sensor Substrate)

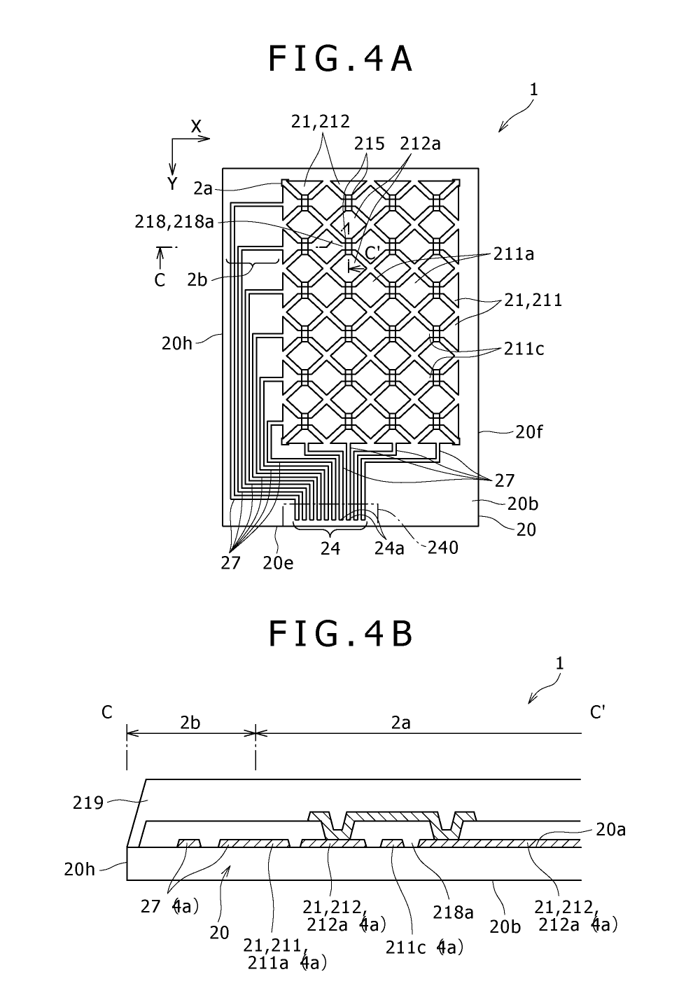

FIGS. 4A and 4B show a configuration of the sensor substrate 20 which uses the electro-optical apparatus 100 with an inputting function according to the embodiment 1 of the present application. More particularly, FIGS. 4A and 4B are a plan view of the sensor substrate 20 and a view schematically showing a section taken along line C1-C1′ of FIG. 4A, respectively. It is to be noted that, in FIG. 4A, the inputting region 2a is indicated by L-shaped marks which individually represent the positions of the four corners thereof.

Referring to FIGS. 4A and 4B, in the touch panel 1 which uses the electro-optical apparatus 100 with an inputting function of the present embodiment, the lower layer side conductive film 4a, interlayer insulating film 23, upper layer side conductive film 4b and light transmitting overcoat layer 24 are formed in order from the lower layer side toward the upper layer side as viewed from the sensor substrate 20 on the first face 20a side of the sensor substrate 20. In the present embodiment, each of the lower layer side conductive film 4a and the upper layer side conductive film 4b is formed from a light transmitting conductive film such as an IT film or an IZO film having a film thickness of 10 to 40 nm. Meanwhile, the interlayer insulating film 23 is a light transmitting insulating film formed from a silicon oxide film or a photosensitive resin having a film thickness of 200 to 600 nm. Also the overcoat layer 24 is formed from a silicon oxide film, a photosensitive resin film or the like similarly to the interlayer insulating film 23. A substrate protective film formed from a silicon oxide film or the like is sometimes formed over an overall area of the first face 20a of the sensor substrate 20. In this instance, the lower layer side conductive film 4a, interlayer insulating film 23 and upper layer side conductive film 4b are layered in order on the substrate protective film.

The lower layer side conductive film 4a is formed as a plurality of diamond-shaped regions in the inputting region 2a, and such diamond-shaped regions configure pad portions 211a and 212a or large area portions of the input position detecting electrodes 21, particularly of first input position detecting electrodes 211 and second input position detecting electrodes 212. The pad portions 211a and 212a are arrayed alternatively in the X direction and the Y direction. Those of the pad portions 211a which are positioned adjacent each other in the X or first direction are connected to each other through a connecting portion 211c, and a pad portion 211a and a connecting portion 211c configure a first input position detecting electrode 211 which extends in the X direction. In contrast, while the pad portions 212a configure second input position detecting electrodes 212 extending in the Y or second direction, those of the pad portions 212a which are positioned adjacent each other in the Y direction, that is, portions overlapping with the connecting portions 211c, form disconnection portions 218a.

The lower layer side conductive film 4a is formed, in the outer side region 2b of the inputting region 2a, as a plurality of wiring lines 27 extending from the input position detecting electrodes 21, that is, from the first input position detecting electrodes 211 and the second input position detecting electrodes 212, and is further formed, in the proximity of the side end face 20e, a plurality of mounting terminals 24a. The interlayer insulating film 23 is formed over the overall inputting region 2a. The interlayer insulating film 23 has contact holes 23a formed therein. The contact holes 23a are formed at positions at which they overlap with end portions of the pad portions 212a opposing through the disconnection portions 218a. The upper layer side conductive film 4b is formed as the repeating electrodes 215 in a region of the inputting region 2a overlapping with the contact holes 23a. It is to be noted that, on the wiring lines 27 or the mounting terminals 24a, a metal layer of chromium, silver, aluminum, silver-aluminum alloy or the like is sometimes formed as an upper layer or a lower layer with respect to the lower layer side conductive film 4a. If such a multilayer structure as just mentioned is adopted, then the wiring line resistance of the wiring lines 27 can be reduced.

If the lower layer side conductive film 4a, interlayer insulating film 23 and upper layer side conductive film 4b configured in such a manner as described above are placed one on another, then a plurality of input position detecting electrodes 21 are formed on the inner side of the inputting region 2a. In the present embodiment, the input position detecting electrodes 21 include a plurality of rows of first input position detecting electrodes 211 extending in the X direction and a plurality of rows of second input position detecting electrodes 212 extending in the Y direction. The input position detecting electrodes 21, that is, the first input position detecting electrodes 211 and the second input position detecting electrodes 212, are formed from the lower layer side conductive film 4a from between the lower layer side conductive film 4a and the upper layer side conductive film 4b and hence from the same layer. Therefore, on the first face 20a of the sensor substrate 20, a plurality of crossing portions 218 between the first input position detecting electrodes 211 and the second input position detecting electrodes 212 exist. Here, whereas the first input position detecting electrodes 211 extend while they are connected to each other in the X direction also at the crossing portions 218 by the connecting portions 211c formed from the lower layer side conductive film 4a, the disconnecting portions 218a are formed at the crossing portions 218 on the second input position detecting electrodes 212. However, at the crossing portions 218, the repeating electrodes 215 configured from the upper layer side conductive film 4b are formed in the lower layer of the interlayer insulating film 23, and such repeating electrodes 215 electrically connect the pad portions 212a, which are adjacent each other with the disconnecting portions 218a interposed therebetween, to each other through the contact holes 23a of the interlayer insulating film 23. Therefore, the second input position detecting electrodes 212 are electrically connected to each other in the Y direction. It is to be noted that, since the repeating electrodes 215 overlap with the connecting portions 211c with the interlayer insulating film 23 interposed therebetween, there is no possibility of short-circuiting between them.

(Shield Structure)

Referring to FIGS. 3A and 3B, in the touch panel 1 of the present embodiment, the light transmitting conductive film 28 for shielding is formed on the second face 20b side of the sensor substrate 20. Particularly, the light transmitting conductive film 28 is formed so as to extend to edges of the sensor substrate 20. Further, in the present embodiment, the light transmitting conductive film 28 is formed from an ITO film. Further, in the present embodiment, an insulating film 29 formed from a silicon oxide film is formed as an upper layer of the light transmitting conductive film 28 on the second face 20b side of the sensor substrate 20. The insulating film 29 is a protective film for the light transmitting conductive film 28. Although the insulating film 29 is formed so as to extend to the three edges of the sensor substrate 20, it is not formed so as to extend to an edge on the side on which the side end face 20e is positioned, and consequently, the light transmitting conductive film 28 is exposed. Therefore, in the present embodiment, a branch portion 310 of the flexible circuit board 300 is electrically connected to the light transmitting conductive film 28. Accordingly, a shield potential can be applied to the light transmitting conductive film 28 and hence to the flexible circuit board 300.

(Operation for Input Position Detection)

In the touch panel 1 of the present embodiment, the flexible circuit board 300 on which the driving IC 350 is mounted is connected to the mounting terminals 24a of the sensor substrate 20. Here, the driving IC 350 successively outputs a position detection signal in the form of a pulse to the sensor substrate 20 through the flexible circuit board 300. Accordingly, if no capacitance is parasitic on an input position detecting electrode 21, then the driving IC 350 comes to detect a signal of a waveform same as or substantially same as that of the pulsed position detection signal outputted to the sensor substrate 20.

On the other hand, if some capacitance is parasitic on the input position detecting electrode 21, then since some distortion arising from the capacitance appears with the waveform. Therefore, it can be detected whether or not some capacitance is parasitic on the input position detecting electrode 21. Therefore, in the present embodiment, a position detection signal is successively outputted to the input position detecting electrodes 21 to monitor the capacitance parasitic on each of the input position detecting electrodes 21. Consequently, if a finger is positioned in the proximity of any of the input position detecting electrodes 21, then the capacitance of the input position detecting electrode 21 in the proximity of which the finger is positioned increases by an amount corresponding to the capacitance produced between the input position detecting electrode 21 and the finger. Therefore, the electrode in the proximity of which the finger is positioned can be detected.

When such position detection operation is to be carried out, the driving IC 350 outputs a shield potential to the light transmitting conductive film 28 through the flexible circuit board 300. Therefore, even if electromagnetic wave noise tends to enter the sensor substrate 20 from the electro-optical panel 10 which is positioned on the opposite side to the inputting operation face side of the sensor substrate 20, it is blocked by the light transmitting conductive film 28. Consequently, the sensor substrate 20 is less likely to suffer from malfunction arising from electromagnetic wave noise.

Here, the driving IC 350 supplies a signal of a waveform same as that of the pulsed position detection signal supplied to the input position detecting electrode 21 as a shield potential to the light transmitting conductive film 28. According to such an active shield method as just described, for an input position detecting electrode 21 which is an object of detection in the current operation cycle, a state in which no capacitance is parasitic between the input position detecting electrode 21 and the light transmitting conductive film 28 can be implemented. Therefore, even if the shield potential is applied to the light transmitting conductive film 28, it does not disturb the position detection.

(Countermeasure Against Short-Circuiting by Moisture)

Referring to FIGS. 3A and 3B, in the electro-optical apparatus 100 with an inputting function of the present embodiment, the sensor substrate 20 of the touch panel 1 is secured to the upper plate portion 53 of the upper metal framework 50 by an adhering member 72 such as an adhesive, a double-sided adhesive tape or the like. In this instance, the light transmitting conductive film 28 formed on the second face 20b of the sensor substrate 20 and the upper metal framework 50 are positioned closely to each other, and there is the possibility of such short-circuiting by a moisture W as described hereinabove with reference to FIG. 7. Besides, in the present embodiment, the pulsed shield potential is applied to the light transmitting conductive film 28 while the upper metal framework 50 is held at the ground potential.

Therefore, in the present embodiment, on the three side end faces 20f to 20h from among the side end faces 20e to 20h of the sensor substrate 20 except the side end face 20e to which the connection of the flexible circuit board 300 is established, a water-repellent coating layer 6 is formed such that it continuously covers from the side end faces 20f to 20h to upper end portions of the side plate portions 51 of the upper metal framework 50. Accordingly, sticking of moisture to the side end faces 20e to 20h of the sensor substrate 20 can be prevented.

In the present embodiment, a colored water-repellent coating layer is used as the water-repellent coating layer 6. Particularly, the water-repellent coating layer 6 used in the present embodiment is a blue transparent layer.

Here, the water-repellent coating layer 6 is produced by applying a fluorocarbon resin-based water-repellent material dissolved or dispersed in solvent and drying the material to evaporate the solvent. Accordingly, while there is an advantage that the water-repellent coating layer 6 can be formed thin, a place at which the water-repellent coating layer 6 is not formed partially is likely to appear. Therefore, in the present embodiment, the outside dimension of the sensor substrate 20 is set a little smaller than that of the upper metal framework 50 such that an inwardly recessed portion 61 is defined by the side end faces 20f to 20h of the sensor substrate 20 and the upper plate portion 53 of the upper metal framework 50. The recessed portions 61 are used as liquid reserving portions for the coating liquid for forming the water-repellent coating layer 6.

Accordingly, even if the coating liquid is applied excessively so that a place at which the water-repellent coating layer 6 is not formed may not appear, since excessive coating liquid is reserved in the recessed portions 61, the water-repellent coating layer 6 can be formed thin in such a manner that it continuously covers from the side end faces 20f to 20h of the sensor substrate 20 to the side plate portions 51 of the upper metal framework 50. Therefore, even if the water-repellent coating layer 6 is provided, it is possible to prevent deterioration of the dimensional accuracy of the electro-optical apparatus 100 with an inputting function. It is to be noted that, since the recessed portions 61 are utilized as liquid reserving portions, the water-repellent coating layer 6 is formed thicker in the recessed portion 61 than in the portions thereof which cover the side end faces 20f to 20h of the sensor substrate 20 and the portion thereof which covers the upper metal framework 50.

It is to be noted that, on the side end face 20e of the sensor substrate 20 at which connection of the flexible circuit board 300 is established, the water-repellent coating layer 6 may be formed avoiding the branch portion 310. Further, for the side end face 20e of the sensor substrate 20 at which connection of the flexible circuit board 300 is established, some other countermeasure against moisture may be applied.

### Principal Effects of the Present Embodiment

As described above, in the touch panel 1 and the electro-optical apparatus 100 with an inputting function of the present embodiment, since the sensor substrate 20 is secured, at the second face 20b thereof on which the light transmitting conductive film 28 is formed, to the upper metal framework 50 through the adhering member 72, the light transmitting conductive film 28 and the upper metal framework 50 are positioned closely to each other. Also in the case of such a configuration as just described, since, in the present embodiment, the water-repellent coating layer 6 which continuously covers from the side end faces 20f to 20h of the sensor substrate 20 to the upper metal framework 50 is provided, even if moisture tends to stick to the side end faces 20f to 20h of the sensor substrate 20 and so forth, the light transmitting conductive film 28 and the upper metal framework 50 do not suffer from short-circuiting. Therefore, even if an active shield method wherein shielding is carried out while a shield potential of a waveform same as that of a signal supplied to an input position detecting electrode 21 is adopted to the light transmitting conductive film 28 to prevent some capacitance from being parasitic between the input position detecting electrode 21 and the light transmitting conductive film 28 is applied, such a situation that the light transmitting conductive film 28 and the upper metal framework 50 are short-circuited to cause the ground potential to be applied to the light transmitting conductive film 28 can be prevented. Therefore, the active shielding can be carried out favorably using the light transmitting conductive film 28.

Further, the water-repellent coating layer 6 continuously covers from the side end faces 20f to 20h of the sensor substrate 20 to the side plate portions 51 of the upper metal framework 50. Therefore, short-circuiting between the light transmitting conductive film 28 and the upper metal framework 50 to be caused by moisture can be prevented with certainty.

Furthermore, since the recessed portions 61 are formed between the sensor substrate 20 and the upper metal framework 50, they serve as liquid reserving portions when coating liquid is applied, and the film thickness of the water-repellent coating layer 6 becomes thicker in the recessed portions 61 than on the portions thereof which cover the side end faces 20f to 20h of the sensor substrate 20 and the portion thereof which covers the upper metal framework 50. Accordingly, even in the case where the film thickness of the water-repellent coating layer 6 is made thinner at the portions thereof which cover the side end faces 20f to 20h of the sensor substrate 20 and the portion thereof which covers the upper metal framework 50 to suppress the variation of the outside dimension, the water-repellent coating layer 6 can continuously cover from the side end faces 20f to 20h of the sensor substrate 20 to the upper metal framework 50.

Besides, since the portions of the upper metal framework 50 between the upper plate portion 53 and the side plate portions 51 have an R shape, the water-repellent coating layer 6 can continuously cover from the side end faces 20f to 20h of the sensor substrate 20 to the upper metal framework 50 with certainty.

Further, in the present embodiment, since the water-repellent coating layer 6 is colored, even if the film thickness of the water-repellent coating layer 6 is thin, it can be confirmed with certainty by visual observation or the like whether or not the water-repellent coating layer 6 is formed.

### Embodiment 2

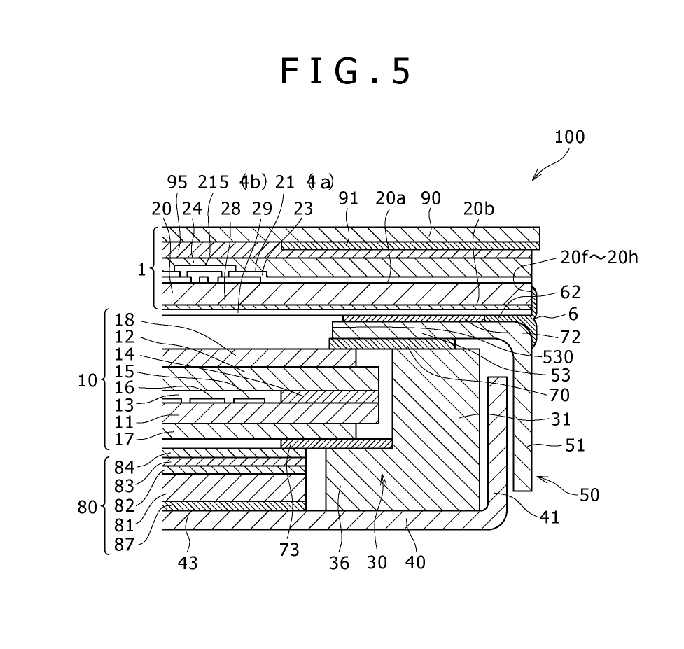

FIG. 5 shows, in an enlarged scale, a cross section of an end portion of an electro-optical apparatus 100 with an inputting function according to an embodiment 2 of the present application. It is to be noted that the present embodiment has a basic configuration similar to that of the embodiment 1, and therefore, like elements to those of the embodiment 1 are denoted by like reference symbols and overlapping description of them is omitted herein to avoid redundancy.

Referring to FIG. 5, also in the touch panel 1 of the present embodiment, a light transmitting conductive film 28 for shielding is formed on the second face 20b side of the sensor substrate 20. Particularly, the light transmitting conductive film 28 is formed so as to extend to edges of the sensor substrate 20. Further, a shield potential of a waveform same as that of a pulsed position detection signal supplied to an input position detecting electrode 21 is applied to the light transmitting conductive film 28. Further, the light transmitting conductive film 28 formed on the second face 20b of the sensor substrate 20 and the upper metal framework 50 are positioned closely to each other. Therefore, in the present embodiment, a water-repellent coating layer 6 is provided which continuously covers from the side end faces 20f to 20h of the sensor substrate 20 from among the three side end faces 20f to 20h, except the side end face 20e to which the connection of the flexible circuit board 300 is established to the side plate portions 51 of the upper metal framework 50. Accordingly, sticking of moisture to the side end faces 20e to 20h of the sensor substrate 20 can be prevented. Also in the present embodiment, a colored water-repellent coating layer is used as the water-repellent coating layer 6 similarly as in the embodiment 1. Particularly, the water-repellent coating layer 6 used in the present embodiment is a blue transparent layer.

Here, the water-repellent coating layer 6 is produced by applying a fluorocarbon resin-based water-repellent material dissolved or dispersed in solvent and drying the material to evaporate the solvent. Accordingly, while there is an advantage that the water-repellent coating layer 6 can be formed thin, a place at which the water-repellent coating layer 6 is not formed partially is likely to appear.

Therefore, in the present embodiment, although the outside dimension of the sensor substrate 20 is equal to that of the upper metal framework 50, the outside dimension of the adhering member 72 is made smaller than the outside dimension of the sensor substrate 20 and the outside dimension of the upper metal framework 50. Therefore, a recessed portion 62 which is concave like a gap is formed between the side end faces 20f to 20h of the sensor substrate 20 and the upper plate portion 53 of the upper metal framework 50. In the present embodiment, the recessed portions 62 are utilized as liquid reserving portions for the coating liquid for forming the water-repellent coating layer 6. It is to be noted that, in addition to the configuration that the portions of the upper metal framework 50 between the upper plate portion 53 and the side plate portions 51 have an R shape, the outside dimension of the adhering member 72 is made smaller than the outside dimension of the sensor substrate 20 of the adhering member 72 and the outside dimension of the upper metal framework 50. Therefore, the recessed portions 62 in the form of a gap of a sufficient depth to allow the recessed portions 62 to be used as liquid reservoirs are formed between the side end faces 20f to 20h of the sensor substrate 20 and the upper plate portion 53 of the upper metal framework 50.

Accordingly, even if the coating liquid is applied excessively so that a place at which the water-repellent coating layer 6 is not formed may not appear, since excessive coating liquid is reserved in the recessed portions 62, the water-repellent coating layer 6 can be formed thin in such a manner that it continuously covers from the side end faces 20f to 20h of the substrate 300 to the side plate portions 51 of the upper metal framework 50. Therefore, even if the water-repellent coating layer 6 is provided, it is possible to prevent deterioration of the dimensional accuracy of the electro-optical apparatus 100 with an inputting function. It is to be noted that, since the recessed portions 62 are utilized as liquid reserving portions, the water-repellent coating layer 6 fills up the recessed portions 62 in the form of a gap.

It is to be noted that, on the side end face 20e of the sensor substrate 20 at which connection of the flexible circuit board 300 is established, the water-repellent coating layer 6 may be formed avoiding the branch portion 310. Further, for the side end face 20e of the sensor substrate 20 at which connection of the flexible circuit board 300 is established, some other countermeasure against moisture may be applied.

As described above, also in the touch panel 1 and the electro-optical apparatus 100 with an inputting function of the present embodiment, since the water-repellent coating layer 6 which continuously covers from the side end faces 20f to 20h of the sensor substrate 20 to the upper metal framework 50 is provided similarly as in the embodiment 1, even if moisture tends to stick to the side end faces 20f to 20h of the sensor substrate 20 and so forth, the light transmitting conductive film 28 and the upper metal framework 50 do not suffer from short-circuiting. In this manner, similar effects to those of the embodiment 1 are achieved.

Furthermore, since the recessed portions 62 in the form of a gap are formed between the sensor substrate 20 and the upper metal framework 50, they serve as liquid reserving portions when coating liquid is applied and are filled up with the water-repellent coating layer 6. Accordingly, even in the case where the film thickness of the water-repellent coating layer 6 is made thinner at the portions thereof which cover the side end faces 20f to 20h of the sensor substrate 20 and the portion thereof which covers the upper metal framework 50 to suppress the variation of the outside dimension, the water-repellent coating layer 6 can continuously cover from the side end faces 20f to 20h of the sensor substrate 20 to the upper metal framework 50.

### Other Embodiments

While, in the embodiments described above, on the second face 20b side of the sensor substrate 20, the insulating film 29 formed from a silicon oxide film is formed as an upper layer to the light transmitting conductive film 28, the embodiment may be applied also where such a insulating film 29 as described above is not formed.

Further, while, in the embodiments described above, the input position detecting electrodes 21 are formed on the first face 20a side of the sensor substrate 20, the embodiment may be applied to a touch panel of another type wherein the input position detecting electrodes 21 are formed on the second face 20b side of the sensor substrate 20 and the light transmitting conductive film 28 is formed on the side nearer to the upper metal framework 50 than the input position detecting electrodes 21.

While, in the embodiments described above, a liquid crystal panel is used as the electro-optical panel 10, the present application may be applied to a case in which a different display panel such as an electroluminescence display panel or a plasma display panel is used as the electro-optical panel 10.

[Examples of Incorporation into Electronic Equipment]

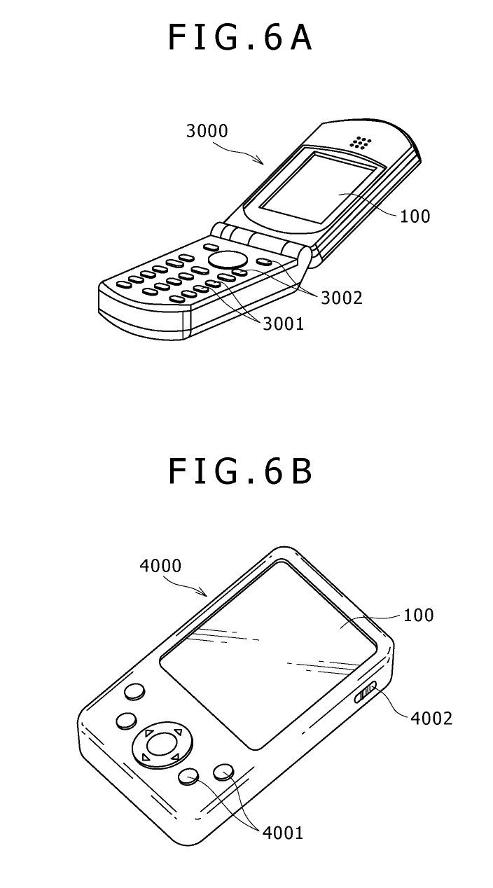

Electronic equipment wherein the electro-optical apparatus 100 with an inputting function according to the embodiments described hereinabove are applied are described. FIG. 6A shows a configuration of a portable telephone set which includes an electro-optical apparatus 100 with an inputting function. Referring to FIG. 6A, the portable telephone set 3000 includes a plurality of operation buttons 3001, a scroll button 3002, and an electro-optical apparatus 100 with an inputting function as a display unit. If the scroll button 3002 is operated, then a screen image displayed on the electro-optical apparatus 100 with an inputting function is scrolled. FIG. 6B shows a configuration of a personal digital assistant to which the electro-optical apparatus 100 with an inputting function is applied. Referring to FIG. 6B, the personal digital assistant 4000 includes a plurality of operation buttons 4001, a power supply switch 4002 and an electro-optical apparatus 100 with an inputting function as a display nit. If the power supply switch 4002 is operated, then various kinds of information such as an address book, a schedule table and so forth are displayed on the electro-optical apparatus 100 with an inputting function.

It is to be noted that the electro-optical apparatus 100 with an inputting function can be applied not only to the electronic equipment described above with reference to FIGS. 6A to 6C but also to various other electronic equipment including a digital still camera, a liquid crystal television set, a video tape recorder of the viewfinder type or the monitor direct-view type, a car navigation system, a pager, an electronic notebook, a desk-top calculator, a word processor, a work station, a visual telephone set, a POS (point-of-sale) terminal and equipment or the like including a touch panel. The electro-optical apparatus 100 with an inputting function described above can be applied as a display section of such various electronic equipment.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. A touch panel, comprising:
a sensor substrate for input position detection secured to a metal framework disposed on the opposite side to an inputting operation face side thereof with an adhering member interposed therebetween;
a light transmitting conductive film formed on the face of said sensor substrate on the opposite side to the inputting operation face so as to extend to edges of said sensor substrate, a potential different from a potential of said metal framework being applied to said light transmitting conductive film; and
a water-repellent coating layer for continuously covering from side end faces of said sensor substrate to said metal framework.

2. The touch panel according to claim 1, wherein
an input position detecting electrode whose capacitance variation is monitored is formed on the inputting operation face side of said sensor substrate, and
said light transmitting conducive film is a shielding electrode to which a potential different from the potential of said metal framework is applied.

3. The touch panel according to claim 1, wherein
said metal framework has an upper plate portion on which said sensor substrate is mounted and side plate portions extending bended downwardly from outer peripheral edges of said upper plate portion, and
said water-repellent coating layer continuously covers from the side end faces of said sensor substrate to the side plate portions of said metal framework.

4. The touch panel according to claim 1, wherein
a recessed portion is configured between said sensor substrate and said metal framework, and
said water-repellent coating layer has a thickness which is thicker at a portion thereof in said recessed portion than at portions thereof which cover the side end faces of said sensor substrate and a portion which covers said metal framework.

5. The touch panel according to claim 1, wherein
a recessed portion in the form of a gap is configured between said sensor substrate and said metal framework, and
said water-repellent coating layer fills the inside of the gap.

6. The touch panel according to claim 1, wherein said water-repellent coating layer is colored.

7. The touch panel according to claim 1, wherein an insulating film is formed on said light transmitting conductive film on the face of said sensor substrate on the opposite side to the inputting operation face.

8. An electro-optical apparatus with an inputting function, comprising:
a touch panel including
a sensor substrate for input position detection secured to a metal framework disposed on the opposite side to an inputting operation face side thereof with an adhering member interposed therebetween,
a light transmitting conductive film formed on the face of said sensor substrate on the opposite side to the inputting operation face so as to extend to edges of said sensor substrate, a potential different from a potential of said metal framework being applied to said light transmitting conductive film, and
a water-repellent coating layer for continuously covering from side end faces of said sensor substrate to said metal framework; and
an electro-optical panel held on said metal framework.
